(19) United States
(12) Patent Application Publication
(10) Pub. No.: US 2009/0274534 A1
(43) Pub. Date: Nov. 5, 2009

(54) Anchor for cover plate engaement

(76) Inventors: Günther Zimmer, Rheinau (DE); Martin Zimmer, Rheinau (DE)

Correspondence Address: KLAUS J. BACH, 4407 TWIN OAKS DRIVE, MURRYSVILLE, PA, 15668, US

(21) Appl. No.: 12/386,573

(22) Filed: Apr. 20, 2009

Related U.S. Application Data
(63) Continuation-in-part of application No. PCT/DE2007/001865, filed on Oct. 19, 2007.

(30) Foreign Application Priority Data
Oct. 19, 2006 (DE) 10 2006 049 921.2

(51) Int. Cl. F16B 13/06

(52) U.S. Cl. 411/57.1; 411/80

(57) ABSTRACT

In an anchor for the attachment to flat building panels including two cover plates and an intermediate support core layer wherein the anchor comprises an expansion body and a wedge body the installed anchor is disposed in an opening of the building component which extends through one of the cover plates and the intermediate support core plate and into a dead end bore formed in the other cover plate. The expansion body includes spreadable clamping elements, wherein, with the anchor installed, the support zone of the expansion body is disposed in radially clamping engagement in the one cover plate and in the dead end bore of the other cover plate.

This is a continuation-in-part application of pending international patent application PCT/DE2007/001865 filed Oct. 19, 2007 and claiming the priority of German patent application 10 2006 049 921.2 filed Oct. 19, 2006.

### BACKGROUND OF THE INVENTION

The invention resides in an anchor for mounting in a planar building component having first and second cover plates with an intermediate support core layer, wherein the anchor includes at least an expansion body and at least one wedge body and wherein the wedge body is at least partially inserted into the expansion body.

Flat construction components with core layer are often designated as sandwich plates, honeycomb plates or light weight construction panels. All panel types used in furniture construction comprise generally cover layers of thin particle boards, medium or high density fiber boards, plywood or hard fiber boards. The sandwich panels often have an intermediate support core structure comprising polyurethane foam or polystyrol. In honeycomb panels often corrugated web inserts or so-called expanded honeycomb structures are used as intermediate layers. Most lightweight construction panels have a raw density below 500 kg/m³. If as intermediate layers no fire resistant foamed aluminum or foamed glass is used, the raw density is below 350 kg/m³. For comparison, the raw density of a normal particle board is about 600 to 750 kg/m³.

If fixtures are to be attached to light-weight panels for example, by screws, the problem arises that the attachment means find support only in the relatively thin cover layers or cover plates. Typical solutions in such cases are spreading anchors as they are disclosed in the printed publication DE 20 204 000 474 V1. The spreading anchors however have the disadvantage that they engage the upper plate in the front and the back side over a large area. The rear engagement additionally displaces the support core material over a large area around the bore, whereby the cover plate is more easily detached from the support core material and is lifted off if the anchor is subjected to high tension forces.

Another anchor which avoids this disadvantage is known from the internet catalog (September 2006) of the comparing Fischer Befestigungssysteme GmbH. It is listed there under the designation SLM-N. The anchor has a tubular expansion body, into whose bore an at least sectionally truncated cone-shaped wedge body is inserted at the rear slotted expansion body end. The wedge body has a central bore with an internal thread. If the wedge body is moved into the expansion body for example by tightening of a retaining screw which is disposed in the thread of the wedge body, the expansion body is spread and clamped, that is, engaged in the lower area of the bore. However, this anchor would require a very rigid core material to be firmly engaged therein.

The object of the present invention is to provide an anchor for lightweight construction panels which is easy to install and which is safely and durably engaged in the light-weight construction panel.

### SUMMARY OF THE INVENTION

The installed anchor is disposed at least partially in an opening of the building component which extends through the first cover plate and the intermediate support core layer and as dead end bore partially into the second cover plate. The expansion body has a support zone with at least two spreadable engagement elements. The wedge body comprises at least one drive element for spreading the clamping elements. With the anchor installed, the support zone of the expansion body—forming a drive structure with the drive element or drive elements of the wedge body—abuts the dead end bore walls of the second cover plate and is radially engaged therein.

With the present invention, an anchor for lightweight construction panels is provided which can be rapidly and firmly installed by hand or by machine in a firmly fixed manner. The anchor includes in the support zone a drive structure via which especially the support zone is spread apart during anchor installation. The drive structure is for example a slide wedge drive wherein a slide wedge is actuated by way of a pull rod which is breakable. The drive structure may for example also be an expansion drive, whose for example star-like spreading elements are actuated by an external push rod. Also an eccentric drive may be used wherein the wedge body may be rotated relative to the expansion body.

The invention will become more readily apparent from the following description of schematically shown embodiments.

### BRIEF DESCRIPTION OF THE DRAWINGS

It is shown in:

FIG. 1: A perspective representation of an expanded anchor;

FIG. 2: An unspread expansion body of the anchor of FIG. 1;

FIG. 3: The wedging body as shown in FIG. 1 with a pull rod;

FIG. 4: An expansion body inserted into a light-weight building panel;

FIG. 5: An installed anchor with the expansion body of FIG. 4;

FIG. 6: The same as FIG. 1 but with different longitudinal slot and partially inserted wedge body;

FIG. 7: An enlargement of a detail of FIG. 6;

FIG. 8: A representation of the lightweight construction panel bore;

FIG. 9: An anchor with a conical pull wedge;

FIG. 10: Like FIG. 9, but with spread-apart clamping elements;

FIG. 11: An anchor with ball-shaped pull wedge;

FIG. 12: Like FIG. 11, but with spread apart clamping elements;

FIG. 13: An anchor with spreading drive;

FIG. 14: Like FIG. 13, but with spread clamping elements;

FIG. 15: Top view of a plate spring;

FIG. 16: Cross-section through an undeformed anchor with eccentric spreading;

FIG. 17: Cross-section through a deformed anchor with eccentric spreading;

### DESCRIPTION OF PARTICULAR EMBODIMENTS

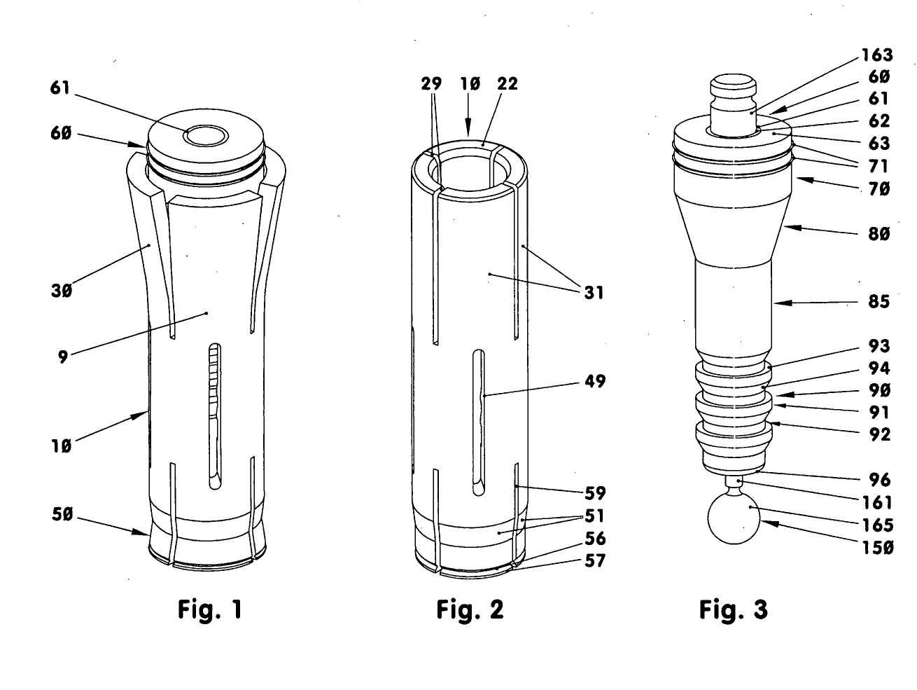

FIG. 1 shows a spread anchor in the form which it would have after installation in a lightweight construction panel. In this embodiment, the anchor has only two parts, an expansion body (10) and a wedge body (60). Both parts (10, 60) are shown separately in FIGS. 2 and 3. The anchor according to FIG. 1 has for example a length of 37.5 mm. The opening drilled for mounting the anchor has for example a diameter of 8.5 mm. The diameter of the unexpanded anchor is in this design either maximally three times the core diameter of the screw to be installed via the anchor in the lightweight building plate or, maximally 2.3 times the actual diameter of the screw when threaded into the anchor.

The anchor is provided for example for the mounting of fixtures to light-weight construction panels (100) without walers and solid inserts, see FIG. 8. The shown lightweight building panel (100) comprises two cover plates (101) and 111) and an intermediate support core (121). Each cover plate (101, 111) consists in the shown embodiment of a thin particle board. The support core (121) is for example a PU foam core. The cover plates (101, 111) are glued with their inner surfaces (103, 113) to the plate-shaped support core (121). The lightweight building panel has a wall thickness of 37.5 mm. Each cover plate is in this case four millimeters thick. Instead of a foam core, a honeycomb core structure may be provided. The lightweight construction panel includes a bore (130) which comprises the sections (105), (125), and (115). The latter section (115) is a dead end bore. Its depth in the embodiment shown is 75% of the material thickness of the lower cover plate (111). Instead of a dead end bore (115), a through-bore may also be used.

The lightweight construction panel (100) may also be curved, that is, it may be of cylindrical or spherical shape, as long as the material thickness of the support core (121) is at least approximately constant.

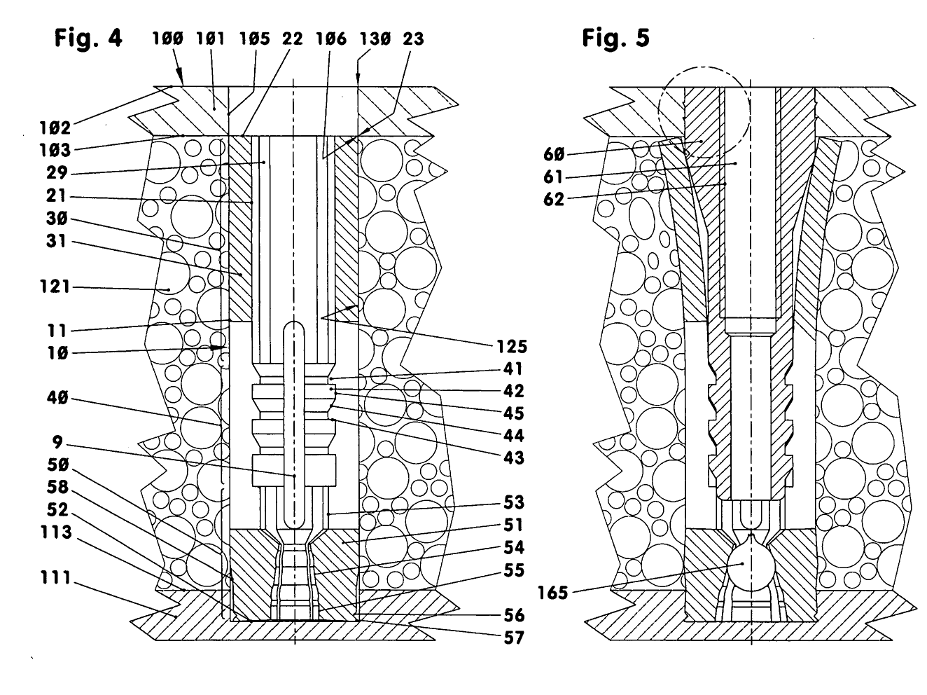

In accordance with FIG. 4, the expansion body (10) has essentially the shape of a tube, that is, it is a tubular body with an upper front face (22) and a lower front face (52). The expansion body (10) is divided into three areas; an engagement section (20), a locking zone (40) and a support section (50).

As shown in FIGS. 1 and 2, the upper area of the expansion body (10) which is for example cylindrical, has for example four straight longitudinal slots (29). The slots (29) however may also be spirally curved. They separate four locking elements (31) from one another. The length of the longitudinal slots (29) is for example 40 to 60% of the length of the expansion body. Their width is in the exemplary embodiment 0.5 mm and is constant over the full length of the anchor as long as it is not deformed. The longitudinal slots (29) have a 90° spacing. The longitudinal slots may also be spirally curved. They may end in radially arranged stress-relieving bores.

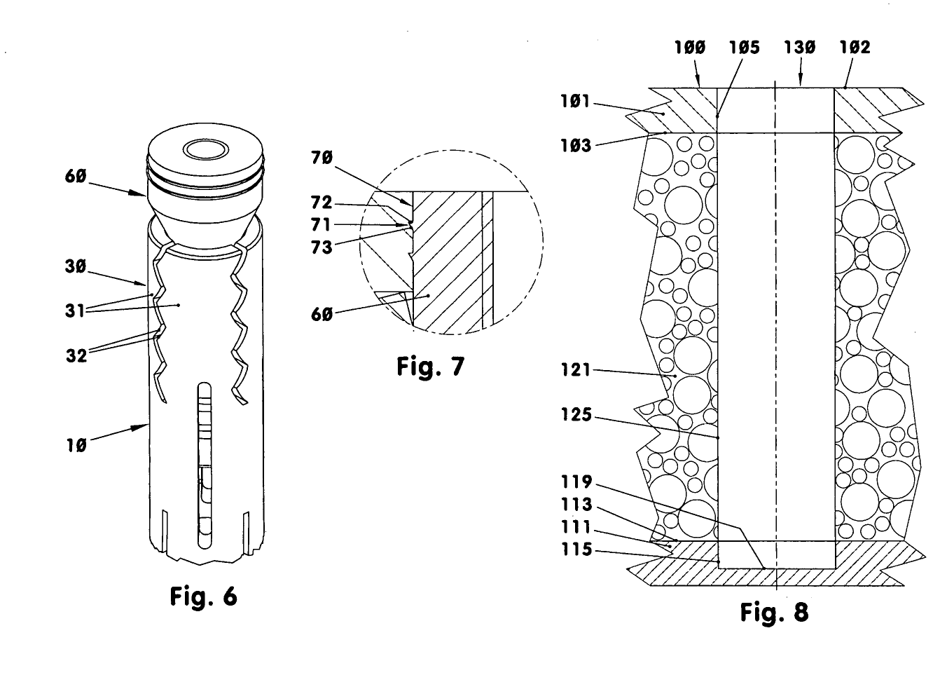

FIG. 6 shows an expansion body (10) which is provided for example with a zigzag, meander-shaped or merlon-like longitudinal slot (29). Upon unintended rotation of the installed anchor in the area of the support core (121) by threading in of a screw, not shown, into the anchor—part of the locking flank sections (32) of the adjacent locking elements (31) come into supportive contact with one another.

In the area of the locking elements (31), the inner wall (21) of the expansion body (10) has a cylindrical form.

At the upper end of the locking element (31) the expansion body (10) has a front face area (22) which in the present case is flat. Expediently, it may also have the shape of a flat truncated cone sleeve whose fictive tip is disposed on the center line (9) of the anchor above or below the upper expansion body end. In such a case, as cone angle, an angle of for example 156 angular degrees may be provided.

Since the expansion body (10) has a length which is equal to, or slightly smaller than, the shortest distance between the inner surfaces (103) of the cover plates (101, 111), the front face (22) is disposed, within the usual tolerances, in the plane of the inner surface (103) of the upper cover plate (101). According to FIG. 4, the outer edge (23) of the front face area (22) is disposed opposite the inner edge (106) of the bore (105). At its inner and outer edge the front face (22) is a chamfered or rounded, see FIG. 2.

Below the locking elements (31), there is a locking zone (40) which consists for example of three engagement projections (41) and three engagement recesses (42) which are arranged alternately one behind the other. The individual annular support projection (41) which has several interruptions has a saw tooth-like cross-sectional shape. The engagement projection distance is about one fourth of the expansion body diameter.

The individual support projection (41) is provided with a slide flank (44) and a support flank (43). The support flank (43) which, in accordance with the FIGS. 4 to 7, is disposed always below the slide flank (44) of the same support projection (41) is part of a plane which extends normal to the center line (9). The slide flank (44) has the form of a truncated cone sleeve. The cone angle of the sleeve is for example 60 angular degrees, wherein the imaginary tip, which is disposed on the centerline (9), is always below the support flank (43) of the respective support projection (41).

It is possible that, for increasing the engagement effect, also the slide flank (44) has the shape of a truncated cone sleeve whose imaginary tip is disposed in the area of the same support projections (41) or thereabove.

The bottom (45) of the engagement grooves (42) has a diameter which corresponds to the diameter of the cylindrical inner wall (21) of the engagement section (30).

In the area of the locking zone (40), there are in this case four relief slots (49) which extend parallel to the anchor center line (9). They are arranged in each case opposite the longitudinal slots (29) displaced by 45 angular degrees. The relief slots (49) which are rounded at their ends may extend upwardly and downwardly 0.1 to 3 mm beyond the locking zone. The width of the relief slots (49) is twice the width of the longitudinal slots (29). In the shown embodiment, this is one millimeter.

Adjacent the locking zone (40) toward the bottom, there is the at least partially cylindrical bottom section (50). Its outer contour which extends around for example a control cavity (53-55) ends with the lower end face (52). The upper part (53) of the cavity has a diameter which corresponds to the minimum diameter of the support projection (41). The intermediate part (54) of the cavity has for example the shape of a straight truncated cone whose tip angle is for example 16 degrees. The intermediate part becomes narrower toward the front face (52). Adjacent thereto there is for example a short cylindrical section (55). The front face (52) in this case also has the shape of a truncated cone sleeve, whose tip angle is 172 angular degrees. The fictive cone tip is disposed on the center line (9) within the area of the cylindrical section (55).

When installed, the expansion body 10 is disposed with the support section (50) in the dead end bore (115) with little or no radial play. To this end, the outer contour of the support section (50) has a special shape. It is divided, with the expansion body undeformed as shown in FIG. 4, into a cone-shaped area (58) and a cylindrical area. The diameter of the cylindrical area is about 0.4 millimeter less than the outer diameter of the outer contour (11). The length of the cylindrical area is greater than the depth of the bore (115).

At the lower rim of the cylindrical area of the outer contour, a circumferential groove (56) is provided so as to form a clamping web (57). The groove (56) has a triangular cross-section. The depth of the groove is 0.2 to 0.5 millimeter. The flanks of the groove define therebetween an angle of for example 90 angular degrees. The lower flank of the groove (56) is spaced from the front surface (52) for example by 0.2 to 0.5 millimeters.

Alternatively to the structure formed by the groove (56) and the engagement web (57), the outer contour of the support zone (50) may be provided with one or more pitched thread, a circumferential transverse knurls or a nub structure.

Like the engagement section (30), the support zone (50) has for example four longitudinal slots, see FIGS. 1 and 2. The length of the slots (59) is for example 25 to 35% of the length of the expansion body. Its width in the shown embodiment is 0.5 millimeter and, in an undeformed anchor, is constant over the full length thereof. The longitudinal slots (59) have a 90° spacing and extend for example in alignment with the slots (29). For stress relief, the longitudinal slots (29) may be provided at their ends with radially arranged relief bores.

The front surface (52) of the expansion body (10) comes into contact at its outer edge with the bottom wall (119) of the dead end bore (115) generally without any axial play.

The front surface (52) of the expansion body (10) may also be concavely curved or it may be structured so that it is in contact with the bottom wall (119) only by line contact, point contact or partial area contact. The roughness depth of a possibly used structure is about 0.5 millimeter.

FIG. 3 shows a wedge body (60), see also FIG. 5. The shown wedge bodies (60) are rotationally symmetric components, at least over certain areas. They have in the shown example three sections: a seating section in the form of a cylinder zone (70), a spreading section forming a wedge zone (80), possibly an intermediate section (85) and a locking zone (90).

The wedge body (60) has a central bore (61) for example with an internal metric thread (62), see FIG. 5. The thread (62) of the bore (61) ends in the exemplary embodiments shortly ahead of the locking zone (90).

Alternatively, the bore (61) may have a rectangular, oval, polygonal or star-like cross-section for accommodating non-metallic screws, such as particle plate screws or wood screws. Possibly, the bore cavity cross-section becomes smaller from the entrance end toward the inner end.

The seating section (70) of the wedge body (60) has an essentially cylindrical outer contour, see FIG. 3. This section (70) is disposed in connection with an anchor installed in a lightweight building panel (100) in the bore (105) of the upper cover plate (101) possibly with a press-fit. According to FIG. 5 one fourth to one third of the length of the seating section (70) extends additionally into the area of the support core (121). The purely cylindrical part of the seating section (70), the cylinder zone, has here an outer diameter which corresponds to the inner diameter of the bore (105). In FIGS. 3 and 5, the seating section (70) has two circumferential retaining hook webs (71). The closed, annular retaining webs (71) have each a triangular cross-section, see FIG. 5 with a support flank (72) and a slide flank (73), see FIG. 7. They project for example 0.15 mm over the respective cylindrical outer contour. They provide for a clamping of the wedge body (60) in the bore (105) which prevents rotation of the wedge body (60) in the bore (105). Additionally, the retaining hook webs seal the installation gap between the wedge body (60) and the light-weight construction panel (100), so that neither dirt nor moisture can enter. Also, in this way, no support core material can reach the ambient.

Alternatively, the seating section (70) may include a plurality of longitudinal webs (74), see FIG. 7. In the present case, it has 15 longitudinal webs (74). All webs extend parallel to the centerline (9) of the anchor. Also, in this case, each web (74) has a triangular cross-section, wherein its flanks enclose for example an angle of 90° degree. Expediently, the cross-sections of the webs (74) increase from top to bottom. This increases the tightness of the mounting gap.

The seating section (70) is followed by the wedging zone. The latter comprises a truncated cone whose fictive tip is arranged in the zone below (85) or (90) on the centerline (9). The acute angle is between 30 and 45 angular degrees. In the embodiment shown, it is 33.4°. The minimum outer diameter of the wedging zone (80) corresponds to the inner diameter of the undeformed engagement section (20) of the expansion body (10).

In the embodiment shown, the wedging zone (80) is followed by a cylindrical intermediate section (85) and the locking zone (90). At least the end of the intermediate section (85) adjacent the locking zone (90) has the same outer diameter as the inner diameter of the undeformed engagement section (20). Independently of the representations of FIGS. 3 and 4, the wedging zone (80) and the intermediate section (85) can be combined to a rotationally symmetrical wedging section wherein the cross-sections of this new wedging section increases continuously from the locking zone (90) to the cylinder zone (70) and, at least in some areas, in a non-linear manner, see FIG. 7. There, the locking elements (31) are engaged by the wedging body (60) at least over some part thereof.

The locking zone (90) of the wedge body (60) is in its design similar to the locking zone (40) of the expansion body (10). From top to bottom, there are three adjacent locking projections (91) of a locking groove (92), see FIG. 3. The spacing and the profile shape are known from the earlier described locking zone (40). Also, in this case, the locking projections (91) have each a planar support flank (93). However, the support flank is provided on top of each locking projection (94).

As shown in the figures, locking occurs exclusively in the separate locking zones (40, 90). But it is also possible to arrange the locking zones partially or completely for example in the wedging zone (80) or in the area of the engagement elements (31) and/or the clamping elements (51). The locking zone (90) ends with a bottom wall (96).

The expansion body (10) and the wedge body (60) consist for example of a polyamide.

To facilitate mounting of the anchor, an opening is drilled through the first cover plate (101) and the support body (121), see FIG. 8. The opening is also drilled to a depth of 2.5 mm into the second cover plate (111) which in the shown embodiment has a thickness of four millimeter. The opening is not drilled fully through the cover plate (111). As drilling tool for example a spiral drill is used, which has a tip angle of 180 angular degrees. Also, a front face cutter tool may be used. Depending on the type of anchor, the opening (130) may also be drilled by a stepped face cutter for example if the dead end bore (115) in the lower cover plate (111) is to have a smaller diameter than the rest of the opening (105, 125).

The dead end bore (115) may have an internal contour which is truncated cone-shaped rather than cylindrical. The support zone (50) then has a correspondingly adapted outer contour. Furthermore, instead of a circular cross-section, the dead end bore may have a rectangular, triangular or polygonal cross-section if a suitable manufacturing method is available. Furthermore, it is not necessary that, before the firm clamping, the support zone fits snugly—in shape—into the dead end bore (115). The outer contour of the support zone (50) may for example have an outer shape of the support zone (50) with longitudinal grooves via which it is firmly and non-rotatably clamped in the cavity without any play.

The cavity or, respectively, bore (130) is blown out for example by compressed air or is sucked out.

The expansion body (10) is inserted into the empty bore (130) over the full length as shown in FIG. 4 so that it abuts the bottom wall (119) of the dead end bore 115 of the lower cover plate (111) and its front end face (22) is disposed on the level of the inner surface (103) of the upper cover plate (101). With the use of foamed support cores for example, the expansion body (10) is disposed in the bore (125) only with little play.

Before the installation, in the embodiment according to FIGS. 1 to 5, another wedge body (150) is first inserted into the expansion body (10) from the bottom. The wedge body (150), which below in this embodiment will be called a pull element, consists here of a pull ball (165), a pull rod (161) and a pull anchor (163). The pull element (150) is so inserted into the expansion body (10) that the pull ball (165) abuts in a parking groove (166), see FIGS. 11 and 12.

For the insertion of the wedge body (60) into the expansion body (10), the wedge body (60) is placed onto the pull element (150) which projects from the expansion body (10).

Upon insertion of the wedge body (60) into the bore (21, 51) of the expansion body (10), the wedging zone (80) of the wedge body (60) presses the locking elements (31) of the expansion body (10) elastically apart, so that they extend behind the inner surface (103) of the first cover plate (101). The front face area (22) may be so designed, that it abuts with the whole face area thereof, the inner surface (103) of the cover plate (101).

At the end of the insert movement of the wedge body (60), the cylinder zone (70) is disposed with a residual radial tension force in the bore section (105) and ends at least essentially in alignment with the outer surface (102) of the first cover plate (101). The upper planar front face (63) of the wedge body (60) may be disposed one to three fourth of a millimeter below the outer surface (102) of the cover plate (101).

At the end of the spreading movement of the engagement elements (31) and the clamping elements (51), the locking projections (91) of the wedge body (60) are locked to the locking grooves (42) of the expansion body (10) in a non-releasable manner. During the three locking jumps occurring in the process, the expansion body (10) was each time expanded momentarily to a barrel-like shape. In the process, the relief slots (49) of the expansion body (10) were temporarily elastically expanded. After completion of the locking procedure, the expansion body (10) assumes in the locking zone (40) again a cylindrical contour (11).

Finally, the pull cable (165) is moved, by way of the pull rod (161) out of the parking groove (166) into the groove (167), see FIGS. 11 and 12. This results in a spreading out of the elastic clamping elements (51) disposed in the bore (51), see also FIG. 5. The clamping web (57) is then fixedly engaged with the wall of the dead end bore (115). The clamping web (57) is then, at least in areas, pressed into the material of the lower cover plate (111) for form-locking connection thereto.

As soon as the pull ball (165) is disposed in the groove (107), the pull rod (161) breaks at a design break area (162) disposed above the pull ball (165).

A fixture which, for example, is to be mounted can now be mounted by a screw screwed into the bore (61) of the wedge body (60).

In the manufacture of wooden furniture, the attachment strength of a fixture does not only depend on the pull-out resistance of the screws disposed in the anchors but also in the limiting of setting amounts and in the avoidance of looseness in the direction transverse to the center line of the respective screw. The anchor presented herein is retained in a direction transverse to the anchor center line (9) on one hand, via the cylinder zone (70) in the bore (105) of the first cover plate (101). On the other hand, its support zone (50) is also disposed in the second cover plate (111). This results in two effects that increase the anchor holding force. On one hand, the lower cover plate takes over part of the anchor retaining force by wedging the foot section (95) into the bore (115). On the other hand, the anchor is fixed transverse to the anchor center line (9) in a form and force locking manner. Since in addition, the anchor is, by design, not bendable, the screws disposed in the anchor do not tend to tilt which could result in an accelerated loosening of the connection. As a result, the chances of an unintended loosening or releasing of the fixture are minimized or even prevented.

In the shown embodiments, the wedge body is as far as its outer contour is concerned at least to a large extent, a rotational symmetrical body. Alternatively, however, its various cross-sections or at least part thereof may have square, polygonal oval or otherwise profiled cross-sections. The wedge body (60) together with the expansion body (10) may be interconnected in the locking zone for example by a thread so that the wedge body is not installed in a linear, non-rotating movement, but by a screw-in movement. With the use of a thread in the mounting gap between the expansion body (10) and the wedge body (60), a locking or blocking structure is provided so that the expansion body (60) can no longer be turned out or only with large effort.

In place of the form- and/or force-locking connection between the expansion body and the wedging body by means of locking zones or a thread also a bayonet locking structure may be provided. The connection by means of a thread or a bayonet locking structure is considered to be equally effective as far as the locking zones are concerned.

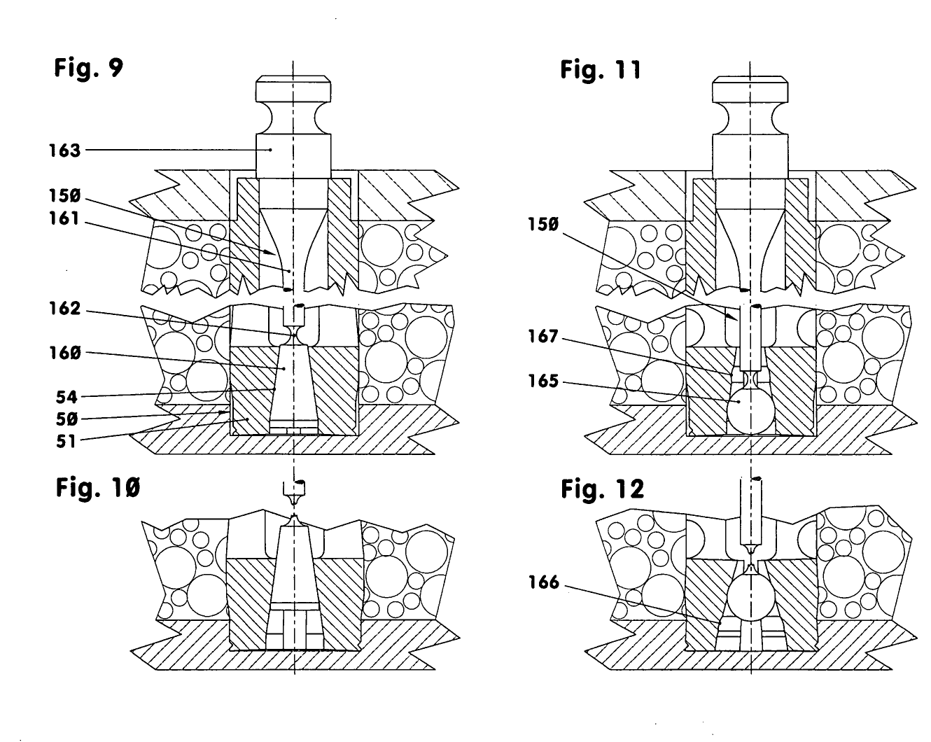

The FIGS. 9 and 10 show an anchor with a wedge body (150) which consists essentially of a pull rod (161) and a pull wedge (160). With an anchor not yet fixed in the bore (130), the pull wedge (160) is disposed, for example, in a conical cavity (54) which becomes wider in downward direction. A pull rod (161) is rigidly connected to the pull wedge (160) by way of a desired break location, for example, a reduced cross-section area (162). In the area extending upwardly from the anchor, the pull rod (161) is provided with a pull anchor (163) which can be engaged by a tool in a formfitting manner.

If, now, the anchor is to be firmly engaged in a lower cover plate, the pull wedge (160) is pulled upwardly by means of the pull rod (161). As soon as—for example two to six—clamping elements (51) are firmly engaged in the bore (115), the reduced cross-section area (162) forming the desired break location breaks. The pull rod (161) is removed from the central bore. The anchor is now firmly engaged at least in the lower cover plate (111).

In the FIGS. 11 and 12, a variant—independently of the type of anchor—is shown, which is partially already disclosed in FIGS. 1 to 5 in connection with the anchor described there. Instead of a pull wedge (160) as shown in FIGS. 9 and 10, the wedge body (150) is a pull ball (165). In an anchor which is not yet fixed in the bore (130), the pull ball (165) is disposed in a parking groove (166). For engaging the clamping elements (51), the pull ball (165) is pulled upwardly until it contacts a stop in another groove (167). Above the pull ball, the desired break location (162) then breaks, see FIG. 12.

The variants of the FIGS. 9-12 represent simple slide wedge drives.

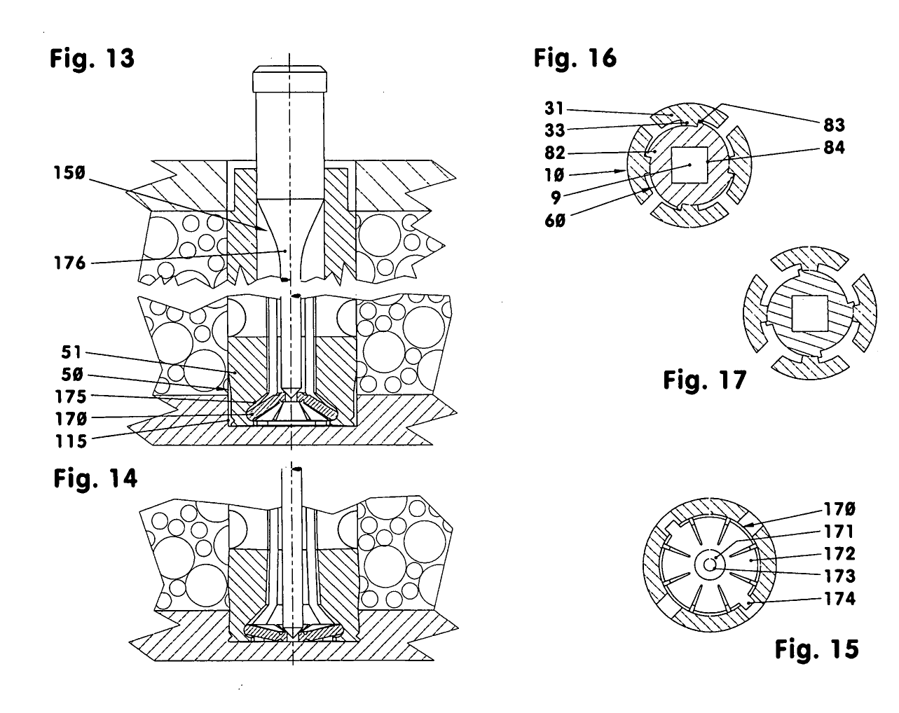

Alternatively, FIGS. 13 to 15 show a wedge body (150) with a straddle drive. Central component of such a straddle drive is a plate spring (170), see FIG. 15.

The plate spring (170) is for example an elastic disc comprising a ring (171) with radially extending tongues (172). Between the ring (171) and the tongues (172) pressure resistant film joints may be arranged. In the shown embodiment, the ring (171) has a central bore (173). Some of the tongues (172) which are dispersed in the area of the longitudinal slots of the clamping zone (50) are provided with projections (174), which extend into the longitudinal slots, see FIG. 15.

The plate spring (170) is disposed in an annular groove (175) arranged in the lower area of the clamping elements (51). In an undeformed anchor, the plate-spring (170) is curved upwardly, that is, the ring (171) is disposed above the tongues (172). For clamping the clamping elements (51), the plate spring is pushed downwardly by means of a push rod (176). The push rod (176) extends for this purpose with its lower end into the bore (173) of the plate spring (170). The plate spring (170) then is curved downwardly in a toggle movement and the ring (171) abuts the bottom of the bore (115). The plate spring (170) is now in a stable end position. The clamping elements are firmly engaged in the bore (115). The push rod (176) is removed upwardly after the clamping engagement of the plate spring (170).

Of course, the anchoring principle is not limited to anchors with at least partially cylindrical outer contour. The anchor may also be designed for example for a cavity which has an at least partially elongated or oval cross-section.

All parts of the anchor which are disposed above the clamping zone (50) are shown here only as examples. The individual anchor may be engaged above the clamping zone (50) with the upper cover plate or the intermediate support core layer (121) in any desired way.

The FIGS. 16 and 17 show a cross-section of an anchor in the area of the clamping zone (50), wherein the wedge body (60) is arranged in the expansion body (10) already before the anchor installation. The anchor is consequently introduced into the bore (130) in a preassembled manner, see FIG. 4. This anchor does not require a pull element (150). The wedging zones of the wedge body (60) in this case are for example four eccentric elements (82) which, by rotation about the longitudinal axis (9) of the anchor, spread the engagement elements (31) and expediently also the engagement elements (51) of the expansion body (10) outwardly. The eccentric elements (82) slide herein along the cams (33) which are provided on the engagement elements (31).

The rotational movement of the wedge body (60) in the expansion body (10) may be limited or arrested for example by engagement elements or stops (83). In the FIGS. 16 and 17 the engagement elements and/or stops are disposed in another sectional plane which is not visible here. To permit pivoting of the wedge body (60) of the support zone (50) about the axis (9) the wedge body (60) is provided for example with a central square opening (84).

### LISTING OF REFERENCE NUMERALS

9 Center line of the anchor
10 Expansion body
11 Outer wall, cylindrical contour
21 Inner wall, bore
22 Front face area
23 Outer edge
29 Longitudinal slots
30 Engagement section
31 Engagement elements
32 Engagement flank sections
33 Cam
40 Locking zone
41 Support projection
42 Engagement recesses, support grooves
43 Support flanks
44 Slide flanks
45 Groove bottom
49 Relief slots
50 Support zone, foot section, support section
51 Clamping element, spreading elements
52 Bottom front face area
53 Cylindrical cavity, chamber
54 Truncated cone sleeve-shaped cavity chamber
55 Cavity, cylindrical
56 Groove
57 Clamping web
58 Outer contour, truncated cone sleeve-shaped
59 Longitudinal grooves
60 Wedge body
61 Bore
62 Internal thread
63 Front face, top
70 Seating section, cylinder zone
71 Barbed webs, circumferential webs, surface structure
72 Support flank
73 Slide flank
80 Spreading section, wedging zone
82 Eccentric elements
83 Stops
84 Square opening
85 Intermediate section
90 Locking zone
91 Engagement projection
92 Engagement recesses, engagement grooves
93 Support flank, planar
94 Slide flank
96 Bottom, front face piston-like end
100 Sandwich panel lightweight composite panel, planar construction component with support core
101 Upper cover plate
102 Outer surface
103 Inner surface
105 Bore
106 Inner edge
111 Lower cover plate
113 Inner surface
115 Dead end bore, dead end cavity
119 Bottom of 115
121 Support core, honeycomb core, foamed material core
125 Bore
130 Overall bore, cavity
150 Wedge body with (160) or (165), pull element
160 Pull wedge
161 Pull rod
162 Reduced cross-section area, desired break area
163 Pull Anchor
165 Pull ball
166 Parking groove
167 Groove
170 Plate spring
171 Tongues
173 Bore
174 Projection
175 Annular groove
176 Push rod

What is claimed is:

1. Anchor for mounting on planar building panels (100) including a support core and having a first cover plate (101) and a second cover plate (111) and at least one intermediate support core layer (121) disposed between the first and the second cover plates (101, 102), the anchor comprising at least one expansion body (10) and at least one single piece wedge body (60, 150) which is at least partially inserted into the expansion body (10),
wherein
the installed anchor is disposed in an opening (130) of the building panel (100) which opening extends through the first cover plate (101) and the intermediate support core layer (121) and as dead end bore (115) partially into the second cover plate (111),
the expansion body (10) includes a support zone (50) with at least two spreadable locking elements (51),
the wedge body (60, 150) has at least one drive element (160, 165, 170, 82) for spreading out the locking elements (51) and,
with the anchor installed in place, the support zone (50) of the expansion body (10)—forming a drive structure with the drive element or elements (160, 165, 170, 82) of the wedge body (60, 150)—is firmly locked in the dead end bore (115) of the second cover plate (111) in radial clamping engagement therewith.

2. Anchor according to claim 1, wherein the clamping elements (51) and the drive element or elements (160, 165) form a slide wedge drive.

3. Anchor according to claim 1, wherein the wedge body (60, 150) includes in addition to a drive element (160, 165, 170) at least one operating element (161, 176) for generating a wedging or spreading effect.

4. Anchor according to claim 3, wherein, for generating a wedge effect, between the drive element (160, 165) and the operating element (161, 176) a desired break location (162) is arranged.

5. Anchor according to claim 3, wherein the operating element is a pull rod (161) or a push rod (176).

6. Anchor according to claim 1, wherein the clamping elements (51) and the drive element or elements (170) form a spreading drive.

7. Anchor according to claim 1, wherein a drive element of the spreading drive is a plate spring (170).

8. Anchor according to claim 1, wherein the clamping elements (51) and at least one drive element (82) form an eccentric drive.

9. Anchor according to claim 1, wherein the support zone (50) of the expansion body extending into the dead end bore (115) of the cover plate (111) has a length which is 30 to 80% of the wall thickness of the cover plate (111).

10. Anchor according to claim 1, wherein the expansion body (10) is tubular at least in the area of the second cover plate (111).

11. Anchor according to claim 1, wherein for forming the clamping elements (51) the expansion body (10) is slotted longitudinally at least over part of the support zone (50).
